(19) United States
(12) Patent Application Publication
(10) Pub. No.: US 2010/0225053 A1
(43) Pub. Date: Sep. 9, 2010

(54) Sheet Feeder And Image Forming Apparatus Including Same

(75) Inventors: Mitsutaka Nakamura, Yokohama-shi (JP); Hidehiko Fujiwara, Tokyo (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/718,574

(22) Filed: Mar. 5, 2010

(30) Foreign Application Priority Data
Mar. 5, 2009 (JP) 2009-051868

(51) Int. Cl. B65H 5/06; F16H 57/10

(52) U.S. Cl. 271/264; 74/411.5

(57) ABSTRACT

A sheet feeder including a sheet feed shaft, a partially cut-out semicircular sheet feed roller coaxially provided to the sheet feed shaft, a cam coaxially provided to the sheet feed shaft, a driven gear having a toothless portion coaxially provided to the sheet feed shaft, a bottom plate movable to contact or separate from the cam, a driving unit to move the driven gear relative to the sheet feed shaft in a direction of rotation of the sheet feed shaft, a drive gear to drive the driven gear, a gear stopping unit to stop rotation of the driven gear at a predetermined timing, a coupling unit to drive the driven gear and the sheet feed shaft in conjunction with each other, and a shaft stopping unit to stop rotation of the sheet feed shaft.

### BACKGROUND

1. Technical Field

This disclosure relates to a sheet feeder employed in an image forming apparatus, and an image forming apparatus including the sheet feeder.

2. Description of the Background

Increasingly, quieter operation is required of image forming apparatuses such as copiers, printers, or multifunction devices having copying and printing functions. In particular, because clients of end users of the image forming apparatuses are often present in the same space where the image forming apparatuses are installed and used, in medical facilities, retail stores, and so forth, noise reduction is strongly demanded.

In most image forming apparatuses, a manual sheet feeder accessible to users is often provided external to the main body of the image forming apparatuses, and is thus a prime source of much operating noise. Moreover, in addition to noise reduction during operation, a simple, inexpensive configuration is also sought for such manual sheet feeders.

One example of a manual sheet feeder with a simple configuration employs a one-revolution clutch system using a chipped tooth gear. Such a manual sheet feeder includes a sheet feed roller, a cam, a chipped tooth gear, a spring boss, a solenoid flapper, and a disk member having a pick that engages the solenoid flapper, each coaxially disposed on a sheet feed shaft. A spring is effectively disposed in the manual sheet feeder to generate a large force to rotate the chipped tooth gear, and the cam, the sheet feed shaft, and the chipped tooth gear are completely synchronized. At first, the chipped tooth gear does not mesh with a drive gear provided to a main body of the manual sheet feeder. However, when a print signal is input, the solenoid flapper and the pick are separated from each other, and the sheet feed shaft is rotated by torque generated by the spring. Accordingly, the chipped tooth gear engages the drive gear. As the sheet feed shaft rotates, a bottom plate pressed toward the cam is moved vertically. Because the bottom plate is automatically moved in the vertical direction as described above, a user does not need to manually move the bottom plate in the vertical direction when setting sheets.

However, in the above-described configuration, the spring is required to have a large force to rotate the sheet feed shaft and the sheet feed roller and to vertically move the bottom plate. Consequently, both impact energy applied to the drive gear from the chipped tooth gear when the drive gear and the chipped tooth gear mesh with each other at the start of sheet feeding as well as the force of impact caused by engagement of the solenoid flapper with the disk member when the solenoid flapper returns to a standby position are considerable, causing much noise.

In another approach, Japanese Patent No. 3517558 (hereinafter referred to as JP-3517558-B) discloses a sheet feeder employing a one-revolution clutch system using multiple chipped gears. The sheet feeder includes first and second chipped gears, first and second stopping means, a sheet feed shaft, a drive gear, and so forth. When the first and second chipped gears mesh with the drive gear, respectively, only the second chipped gear is rotated separately from the sheet feed shaft, so that it is not necessary to rotate the sheet feed shaft. Accordingly, impact applied to the drive gear from the first and second chipped gears is small, achieving quiet operation.

However, because multiple chipped gears are used as described above, a large space is required in a direction of the sheet feed shaft, preventing downsizing of the sheet feeder. Further, because the multiple chipped gears mesh with the drive gear at the same time as described above, vibration occurs due to phase shift between the multiple chipped gears, possibly causing noise and irregular images.

Japanese Patent No. 3912880 (hereinafter referred to as JP-3912880-B) discloses a sheet feeder employing a one-revolution clutch system using a partially toothless gear to vertically move a bottom plate. In the sheet feeder, a disk that engages a solenoid flapper is designed to reduce impact sounds produced by engagement of the solenoid flapper with the disk surface when the sheet feeder returns to a standby state. However, the disk surface cannot effectively reduce the noise of operation.

Japanese Patent No. 4139958 (hereinafter referred to as JP-4139958-B) discloses a sheet feeder employing a one-revolution clutch system using a partially missing gear to vertically move a bottom plate. A disk member that engages a solenoid flapper is provided separately from the partially missing gear, and an elastic member such as a spring is provided between the disk member and the partially missing gear in order to reduce impact sounds produced by engagement of the disk member with the partially missing gear when the sheet feeder returns to a standby state. In the sheet feeder, a sheet feed shaft and the partially missing gear are constantly rotated in the same phase. However, although impact energy is relieved by the elastic member, operating noise cannot be sufficiently reduced.

### SUMMARY

In this disclosure, a sheet feeder employing a one-revolution clutch system using a driven gear having a toothless portion is provided to achieve quieter operation and space reduction.

In one illustrative embodiment, a sheet feeder includes a sheet feed shaft, a partially cut-out semicircular sheet feed roller coaxially provided to the sheet feed shaft, a cam coaxially provided to the sheet feed shaft, a driven gear having a toothless portion coaxially provided to the sheet feed shaft, a bottom plate movable to contact or separate from the cam, a driving unit to move the driven gear relative to the sheet feed shaft in a direction of rotation of the sheet feed shaft, a drive gear to drive the driven gear, a gear stopping unit to stop rotation of the driven gear at a predetermined timing, a coupling unit to drive the driven gear and the sheet feed shaft in conjunction with each other, and a shaft stopping unit to stop rotation of the sheet feed shaft.

In another illustrative embodiment, a sheet feeder includes a sheet feed shaft, a partially cut-out semicircular sheet feed roller coaxially provided to the sheet feed shaft, a cam coaxially provided to the sheet feed shaft, a driven gear having a toothless portion coaxially provided to the sheet feed shaft, a bottom plate movable to contact or separate from the cam, a driving means for moving the driven gear relative to the sheet feed shaft in a direction of rotation of the sheet feed shaft, a drive gear to drive the driven gear, a gear stopping means for stopping rotation of the driven gear at a predetermined timing, a coupling means for driving the driven gear and the sheet feed shaft in conjunction with each other, and a shaft stopping means for stopping rotation of the sheet feed shaft.

In another illustrative embodiment, an image forming apparatus includes the sheet feeder described above.

Additional aspects, features, and advantages of the present disclosure will be more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein like reference numerals designate identical or corresponding parts throughout the several views and wherein:

FIG. 1 is a perspective view illustrating an appearance of an image forming apparatus according to illustrative embodiments;

FIG. 2 is a vertical cross-sectional view illustrating a configuration of the image forming apparatus illustrated in FIG. 1;

FIG. 3 is a perspective view illustrating a configuration of a manual sheet feeder according to a first illustrative embodiment;

FIG. 4 is an enlarged perspective view illustrating a sheet feed shaft including a driven gear having a toothless portion included in the manual sheet feeder illustrated in FIG. 3;

FIG. 5 is an enlarged perspective view illustrating a pick that engages a solenoid flapper provided to an electromagnetic solenoid included in the manual sheet feeder illustrated in FIG. 3;

FIG. 6 is a vertical cross-sectional view illustrating a state in which the solenoid flapper is not in a state of excitation;

FIG. 7 is a vertical cross-sectional view illustrating a state in which the solenoid flapper is in a state of excitation;

FIG. 8 is an enlarged perspective view illustrating a state in which a convex member provided on a bottom plate engages a concavity provided in a cam in the manual sheet feeder illustrated in FIG. 3;

FIG. 9 is a vertical cross-sectional view illustrating an example of a standby state;

FIG. 10 is a vertical cross-sectional view illustrating another example of the standby state;

FIG. 11 is a vertical cross-sectional view illustrating a state of preparation for the start of sheet feeding;

FIG. 12 is a vertical cross-sectional view illustrating a state at the start of sheet feeding;

FIG. 13 is a vertical cross-sectional view illustrating a state in which the driven gear begins to engage a drive gear;

FIG. 14 is a vertical cross-sectional view illustrating a state in which the sheet feed shaft is driven;

FIG. 15 is a vertical cross-sectional view illustrating a state in which the bottom plate is raised;

FIG. 16 is a vertical cross-sectional view illustrating a state during sheet feeding;

FIG. 17 is a vertical cross-sectional view illustrating a state in which the bottom plate descends;

FIG. 18 is a vertical cross-sectional view illustrating a state before the driven gear is separated from the drive gear;

FIG. 19 is a flowchart illustrating operations of the manual sheet feeder according to illustrative embodiments;

FIG. 20 is a perspective view illustrating main components of a manual sheet feeder according to a second illustrative embodiment;

FIG. 21 is an enlarged perspective view illustrating the main components of the manual sheet feeder illustrated in FIG. 20;

FIG. 22 is a perspective view illustrating an example of a driven gear having a toothless portion included in a manual sheet feeder according to a third illustrative embodiment; and

FIG. 23 is a perspective view illustrating another example of the driven gear included in the manual sheet feeder according to the third illustrative embodiment.

### DETAILED DESCRIPTION OF THE ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

Illustrative embodiments of the present invention are described in detail below. It is to be noted that the present invention is applicable to various devices performing image formation in addition to the image forming apparatus that is described below.

A description is now given of a first illustrative embodiment of the present invention.

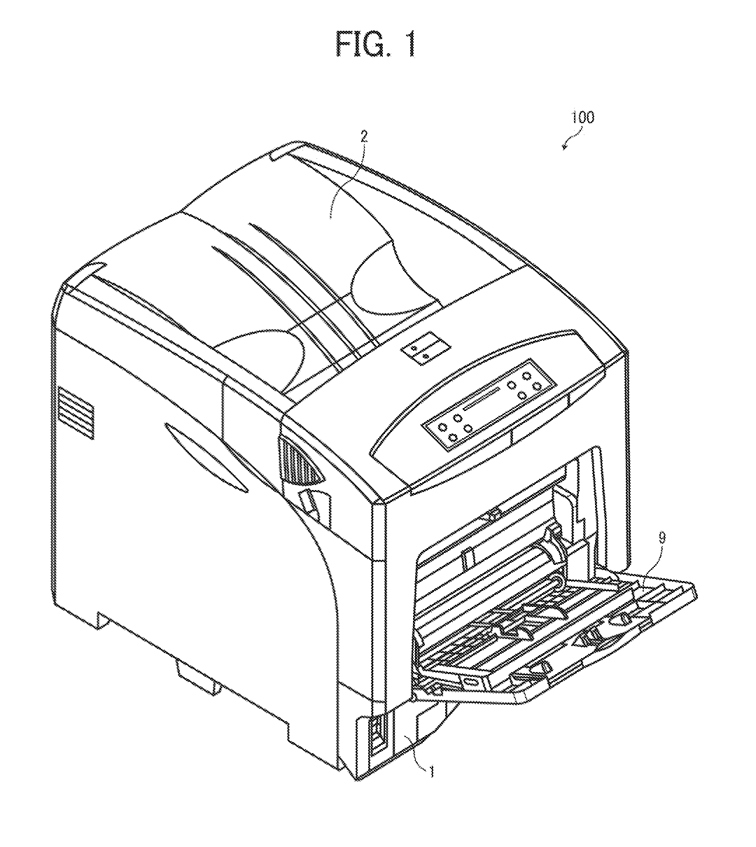

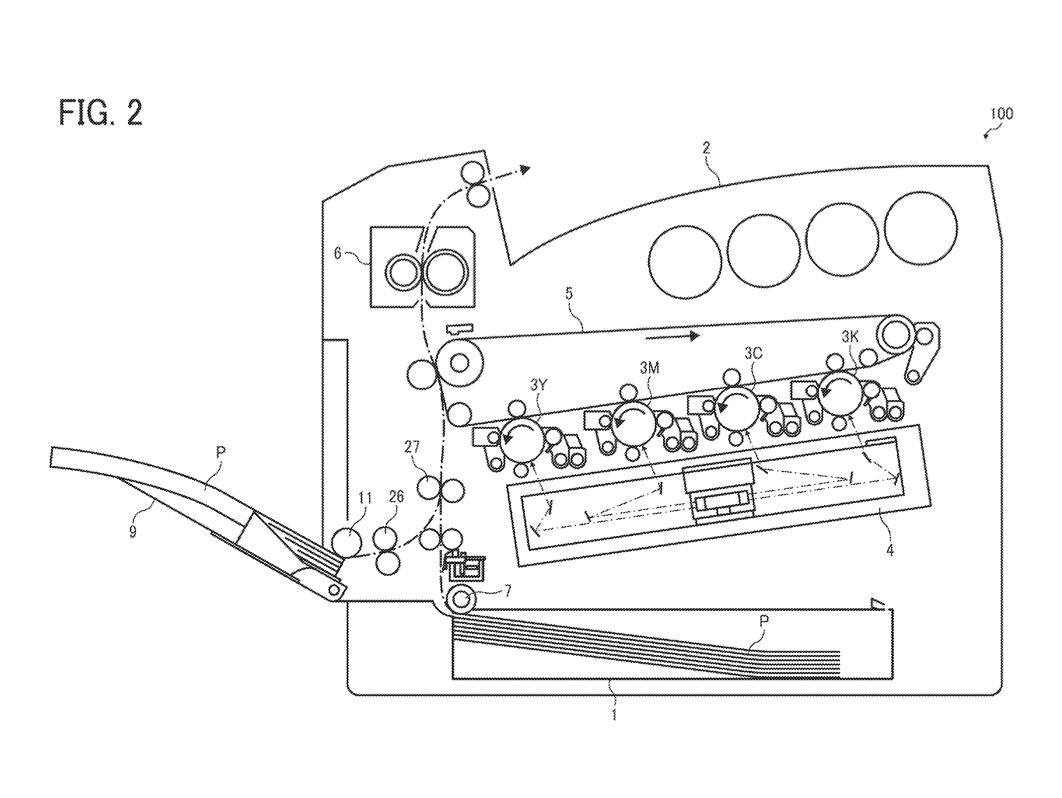

FIG. 1 is a perspective view illustrating an appearance of a laser printer serving as an image forming apparatus 100 according to illustrative embodiments. FIG. 2 is a vertical cross-sectional view illustrating a configuration of the image forming apparatus 100. It is to be noted that although in the present embodiment the image forming apparatus 100 is a laser printer, the image forming apparatus 100 is not limited thereto.

The image forming apparatus 100 includes a sheet feed cassette 1 at the bottom of the image forming apparatus 100. Sheets on which images are formed by the image forming apparatus 100 are discharged to a discharge tray 2 provided at the top of the image forming apparatus 100. The image forming apparatus 100 further includes a manual sheet feeder 9 provided to a front of the image forming apparatus 100.

Within the image forming apparatus 100, drum-shaped photoconductors 3Y, 3M, 3C, and 3K (hereinafter collectively referred to as photoconductors 3), each for a specific color, that is, yellow, magenta, cyan, or black, are provided as illustrated in FIG. 2, and an electrophotographic processing member is provided around each of the photoconductors 3. The image forming apparatus 100 further includes an optical writing unit 4 that directs laser light onto surfaces of the photoconductors 3 to form electrostatic latent images, an intermediate transfer belt 5 that transfers toner images respectively formed on the surfaces of the photoconductors 3 onto a recording medium such as a sheet P, a fixing device 6 that fixes the toner images to the sheet P, and so forth.

A sheet feed path, defined by various members and mechanisms as described below, to feed and convey the sheet P from the sheet feed cassette 1 to the intermediate transfer belt 5 extends substantially vertically along the inside of the front of the image forming apparatus 100. Specifically, the sheet P is fed from the sheet feed cassette 1 provided at the bottom of the image forming apparatus 100 to the sheet feed path by a sheet feed roller 7 and so forth. It is to be noted that the sheet feed cassette 1 is hinged along the bottom and can be opened by pulling the top out and forward.

The sheet P stored in the sheet feed cassette 1 is fed by the sheet feed roller 7 as described above, and is discharged to the discharge tray 2 through the sheet feed path. By contrast, when the sheet P is manually fed, the sheet P placed on the manual sheet feeder 9 is fed by a sheet feed roller 11, and is discharged to the discharge tray 2 through the sheet feed path.

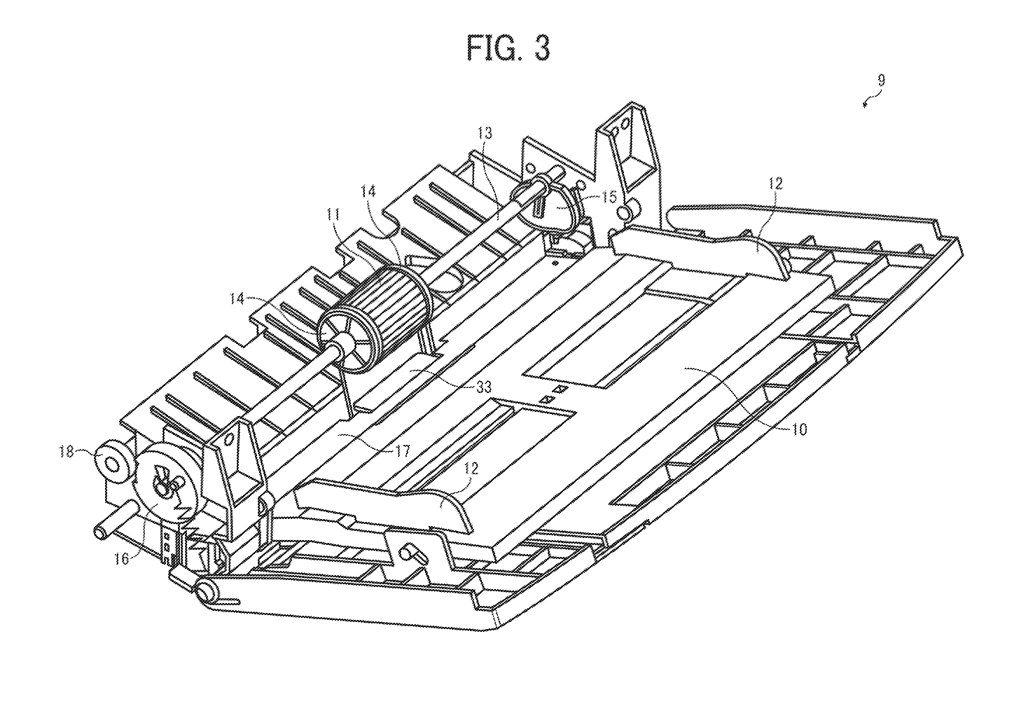

FIG. 3 is a perspective view illustrating a configuration of the manual sheet feeder 9. The manual sheet feeder 9 includes a pair of opposed fence members 12 slidably provided to align edges of the sheet P placed on a sheet stand 10. After the sheet P is set on the sheet stand 10, a user slides the pair of fence members 12 together to align the edges of the sheet P. Accordingly, diagonal sheet feeding can be prevented.

In the manual sheet feeder 9, the partially cut-out semicircular sheet feed roller 11, idle rollers 14, a cam 15, and a driven gear 16 having a toothless portion are coaxially provided to a sheet feed shaft 13. A leading edge of the sheet P is positioned on a bottom plate 17 when the sheet P is placed on the sheet stand 10, and a friction pad 33 is provided at the center of the bottom plate 17. The bottom plate 17 is pressed toward the sheet feed roller 11 and the cam 15 by a biasing member 22 not visible in the view shown in FIG. 3, and is moved vertically by rotation of the sheet feed shaft 13 and the cam 15.

When the sheet P is manually fed from the manual sheet feeder 9, a drive gear 18 is rotated. Rotation of the drive gear 18 is transmitted to the driven gear 16 to rotate the sheet feed shaft 13. The cam 15 is rotated simultaneously with rotation of the sheet feed shaft 13, and the bottom plate 17 is moved vertically in conjunction with rotation of the cam 15. Accordingly, the sheet P placed on the sheet stand 10 is automatically pressed against the sheet feed roller 11 to be fed by the sheet feed roller 11.

FIG. 4 is an enlarged perspective view illustrating the sheet feed shaft 13 provided with the driven gear 16. As illustrated in FIG. 4, the driven gear 16 is movable relative to the sheet feed shaft 13 within a predetermined range in a direction of rotation of the sheet feed shaft 13. A parallel pin 19 is provided to the sheet feed shaft 13 inside a fan-shaped notch 16b provided in the driven gear 16. The parallel pin 19 contacts the notch 16b so that the driven gear 16 and the sheet feed shaft 13 are driven in conjunction with each other. In other words, the parallel pin 19 and the notch 16b in the driven gear 16 serve as a coupling means. A spring 21 is provided as a driving means for rotating only the driven gear 16 separately from the sheet feed shaft 13. One end 21a of the spring 21 is fixed to a hook 16a provided to the driven gear 16, and the other end 21b of the spring 21 is anchored to a frame of the manual sheet feeder 9.

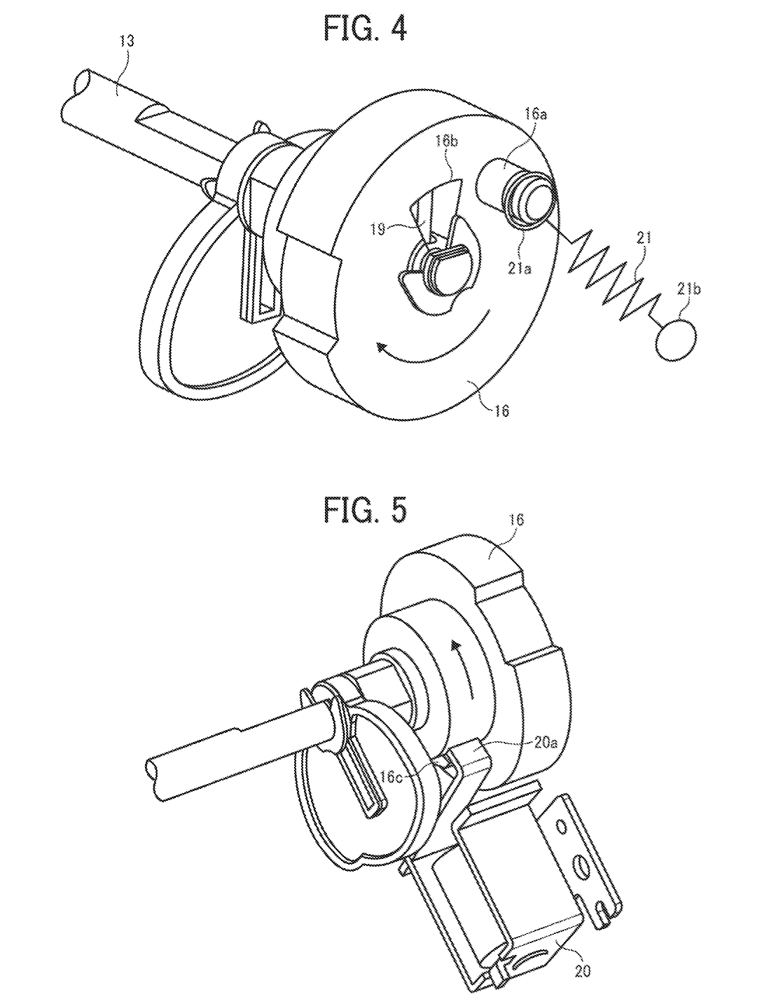

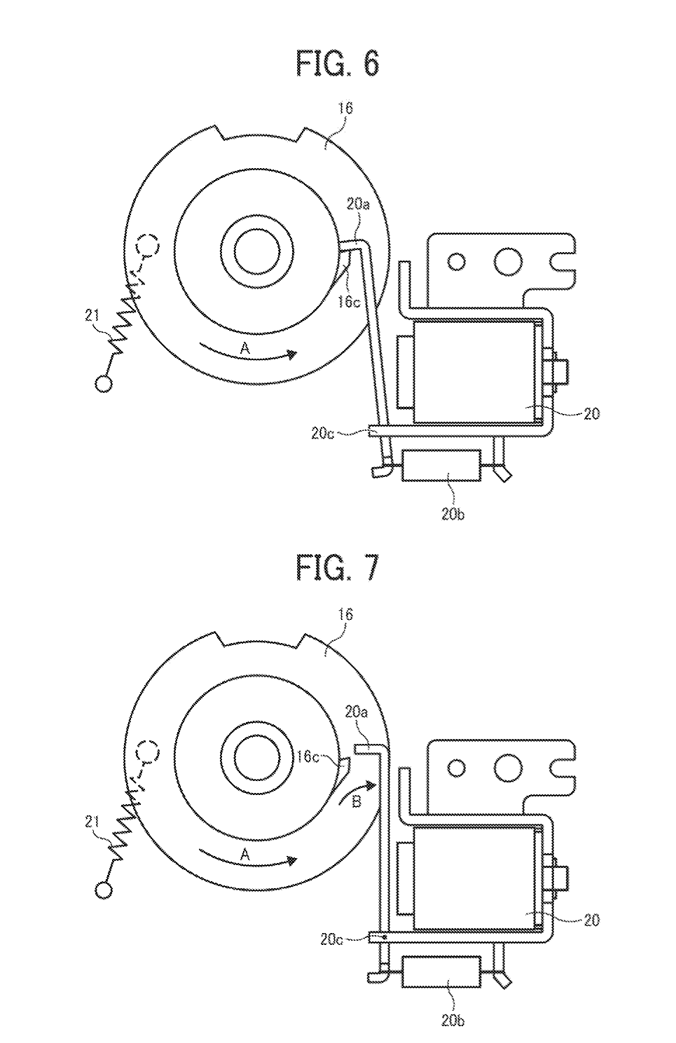

FIG. 5 is an enlarged perspective view illustrating a pick 16c engaging an electromagnetic solenoid 20, more specifically a solenoid flapper 20a. FIG. 6 is a vertical cross-sectional view illustrating a state in which the solenoid flapper 20a is not in a state of excitation, and FIG. 7 is a vertical cross-sectional view illustrating a state in which the solenoid flapper 20a is in a state of excitation.

As illustrated in FIG. 5, the pick 16c serving as a stopper to engage the solenoid flapper 20a of the electromagnetic solenoid 20 is provided to a surface opposite to and axially inboard of the surface of the driven gear 16 having the notch 16b along the sheet feed shaft 13. The pick 16c is integrally formed with the driven gear 16. As illustrated in FIG. 6, when it is not excited, the solenoid flapper 20a is pressed toward the driven gear 16 by a solenoid spring 20b. Accordingly, even if the driven gear 16 is caused to be rotated in a direction indicated by an arrow A in FIG. 6 by the spring 21, rotation of the driven gear 16 is prevented by engagement of the pick 16c with the solenoid flapper 20a. In other words, the pick 16c provided to the driven gear 16 and the electromagnetic solenoid 20 together serve as a gear stopping means. Then, when a sheet feed signal is sent to the electromagnetic solenoid 20 at a predetermine timing, the solenoid flapper 20a is rotated around a pivot 20c in a direction indicated by an arrow B in FIG. 7, so that the solenoid flapper 20a is disengaged from the pick 16c and the driven gear 16 is rotatable in the direction indicated by the arrow A.

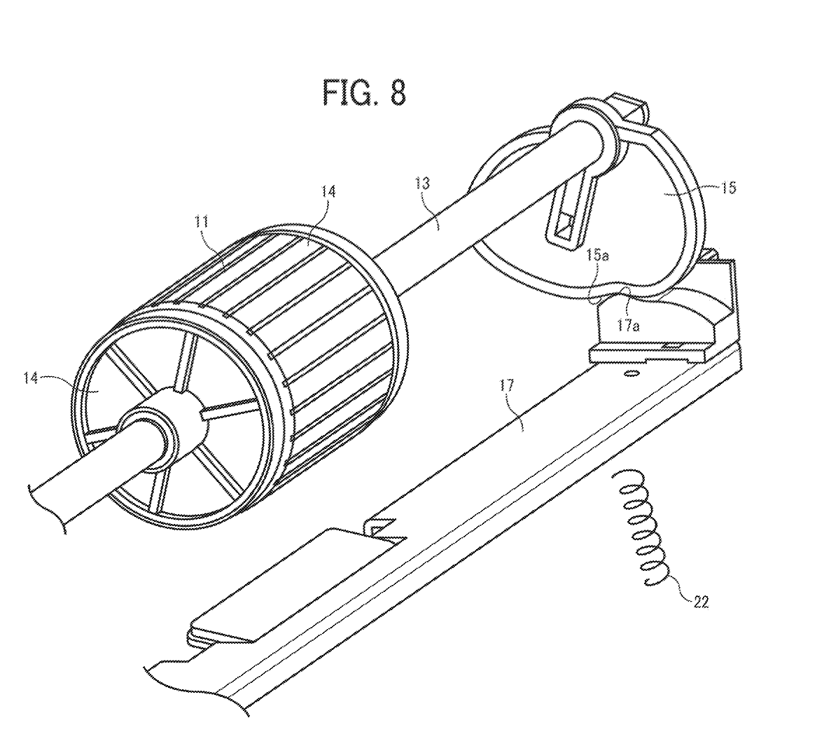

FIG. 8 is an enlarged perspective view illustrating a state in which a convexity 17a provided on the bottom plate 17 engages a concavity 15a provided in the cam 15. As illustrated in FIG. 8, the bottom plate 17 includes the convexity 17a, and the cam 15 includes the concavity 15a. The bottom plate 17 is pressed toward the cam 15 by the biasing member 22 so that the convexity 17a engages the concavity 15a. Accordingly, rotation of the cam 15 and the sheet feed shaft 13 is stopped. In other words, the convexity 17a, the concavity 15a of the cam 15, and the biasing member 22 together serve as a shaft stopping means.

A description is now given of operations of the manual sheet feeder 9 according to illustrative embodiments.

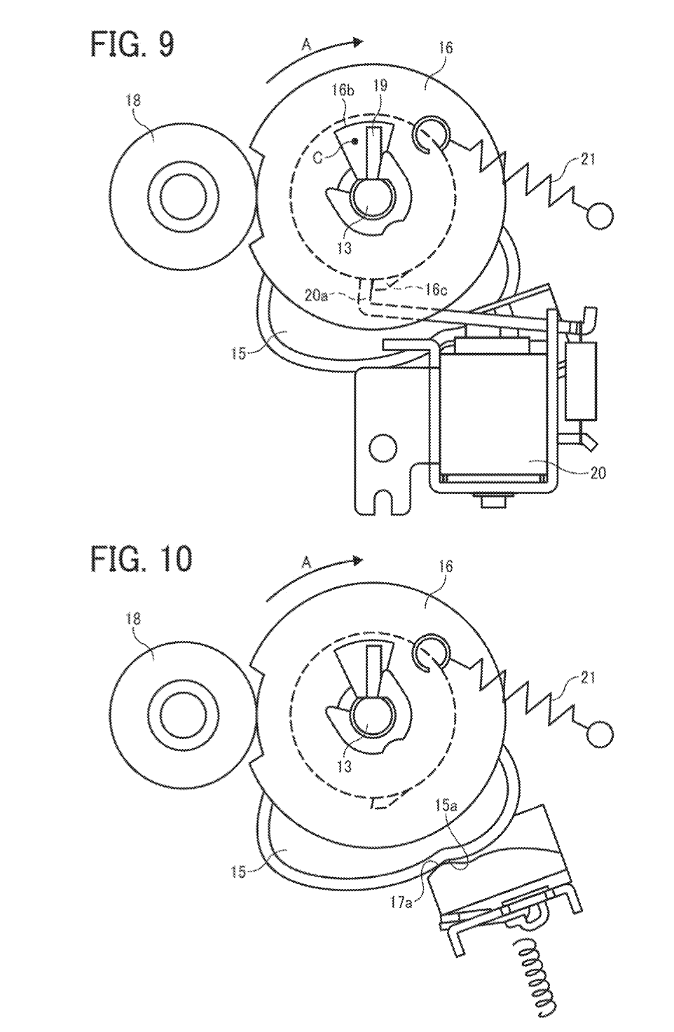

FIGS. 9 and 10 are vertical cross-sectional views respectively illustrating standby states, that is, when sheet feeding is not performed.

During standby, the convexity 17a of the bottom plate 17 engages the concavity 15a of the cam 15, that is, the shaft stopping means is operated, so that rotation of the sheet feed shaft 13 is stopped at a position illustrated in FIGS. 9 and 10. The driven gear 16 movable relative to the sheet feed shaft 13 is pressed toward a direction indicated by the arrow A in FIG. 9 by the spring 21 serving as the driving means. However, because the electromagnetic solenoid 20 is not excited, the gear stopping means, that is, the solenoid flapper 20a and the pick 16c provided to the driven gear 16, is operated as described above to prevent rotation of the driven gear 16.

At this time, the relative positions of the notch 16b of the driven gear 16 and the parallel pin 19 provided to the sheet feed shaft 13 provide a space C such that only the driven gear 16 can be rotated relative to the sheet feed shaft 13 in the direction indicated by the arrow A. In other words, the coupling means is not operated.

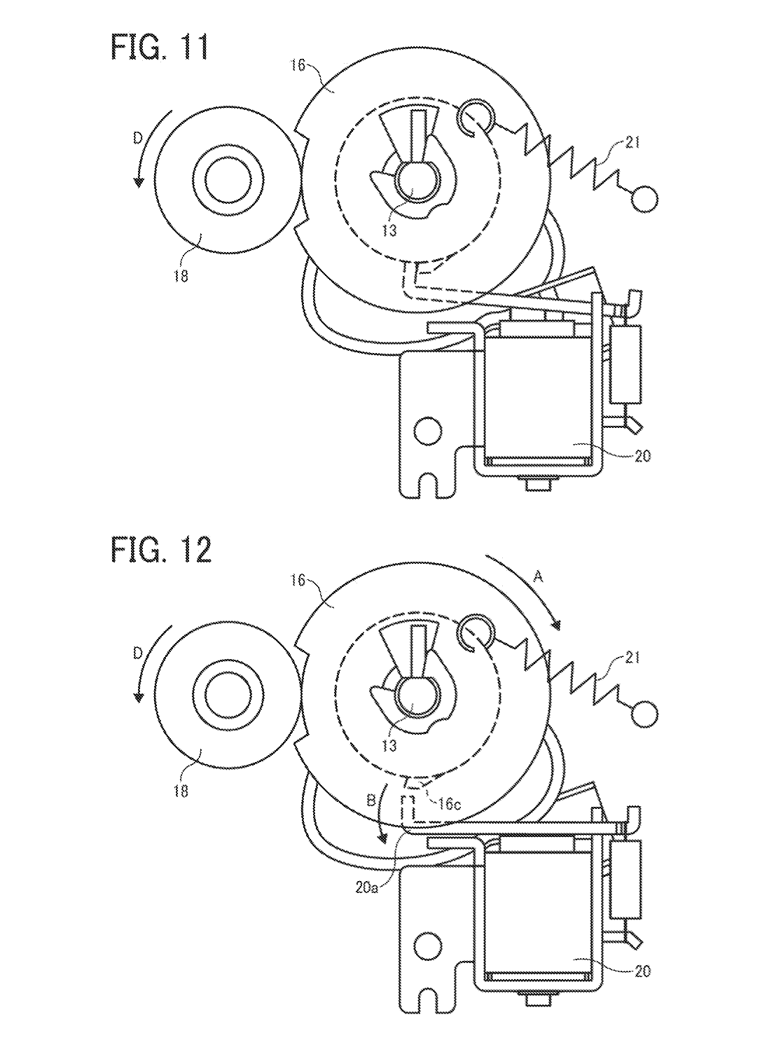

FIG. 11 is a vertical cross-sectional view illustrating a state of preparation for the start of sheet feed.

When a print signal is received, the drive gear 18 is rotated by a driving source, not shown, in a direction indicated by an arrow D in FIG. 11. In general, the drive gear 18 is constantly rotated during continuous sheet feeding regardless of a number of sheets P to be fed.

FIG. 12 is a vertical cross-sectional view illustrating a state at the start of sheet feeding. When a predetermined period of time elapses after the print signal is received, a signal for starting sheet feeding is input so that the electromagnetic solenoid 20 is excited only for a short period of time. Accordingly, the solenoid flapper 20a is rotated in the direction indicated by the arrow B in FIG. 12, so that the gear stopping means is disengaged and only the driven gear 16 is rotated in the direction indicated by the arrow A in FIG. 12 by the force of the spring 21 serving as the driving means. Meanwhile, the shaft stopping means is still operated so that rotation of the sheet feed shaft 13 is stopped.

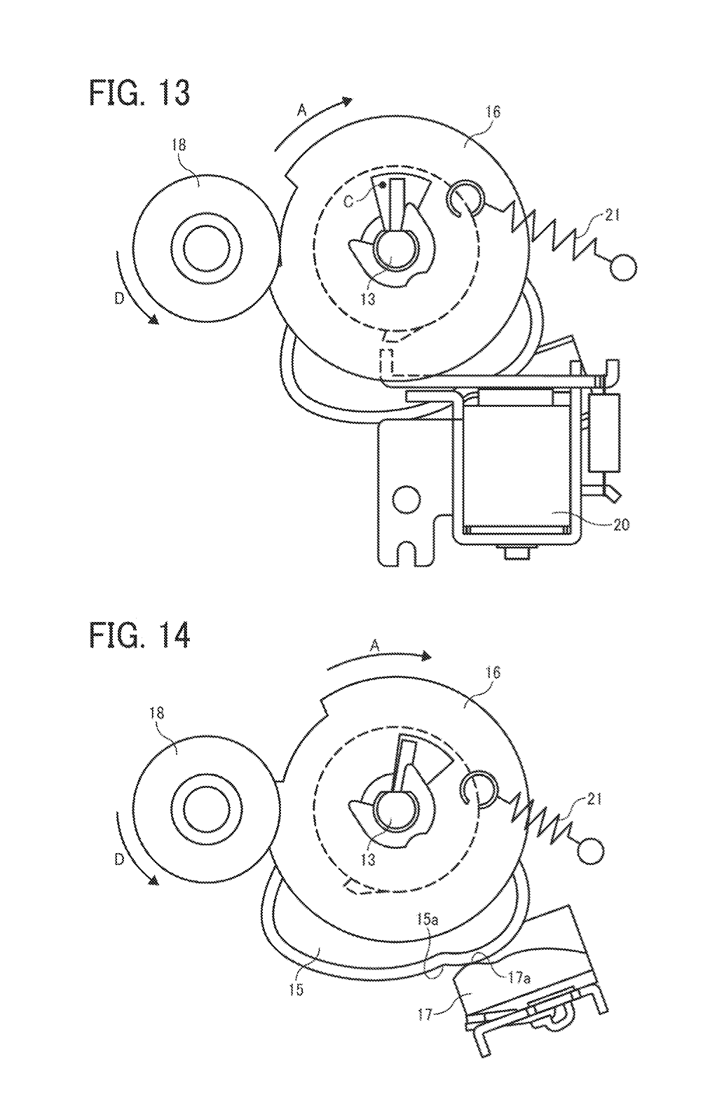

Thereafter, as illustrated in FIG. 13, the driven gear 16 begins to engage the drive gear 18. The space C is kept until the driven gear 16 engages the drive gear 18.

FIG. 14 is a vertical cross-sectional view illustrating a state in which the sheet feed shaft 13 is driven. When the driven gear 16 engages the drive gear 18, the driven gear 16 is rotatively driven by rotation of the drive gear 18. When the driven gear 16 is rotated for a predetermined amount, the space C is lost as illustrated in FIG. 14 so that the coupling means is operated to transmit rotation of the driven gear 16 to the sheet feed shaft 13. At this time, because it is obtained by rotation of the drive gear 18 via the driven gear 16, the force to rotate the sheet feed shaft 13 is sufficiently greater than the force of the shaft stopping means to stop rotation of the sheet feed shaft 13. Accordingly, the concavity 15a of the cam 15 climbs over the convexity 17a of the bottom plate 17 and slightly presses the bottom plate 17 downward to release the shaft stopping means.

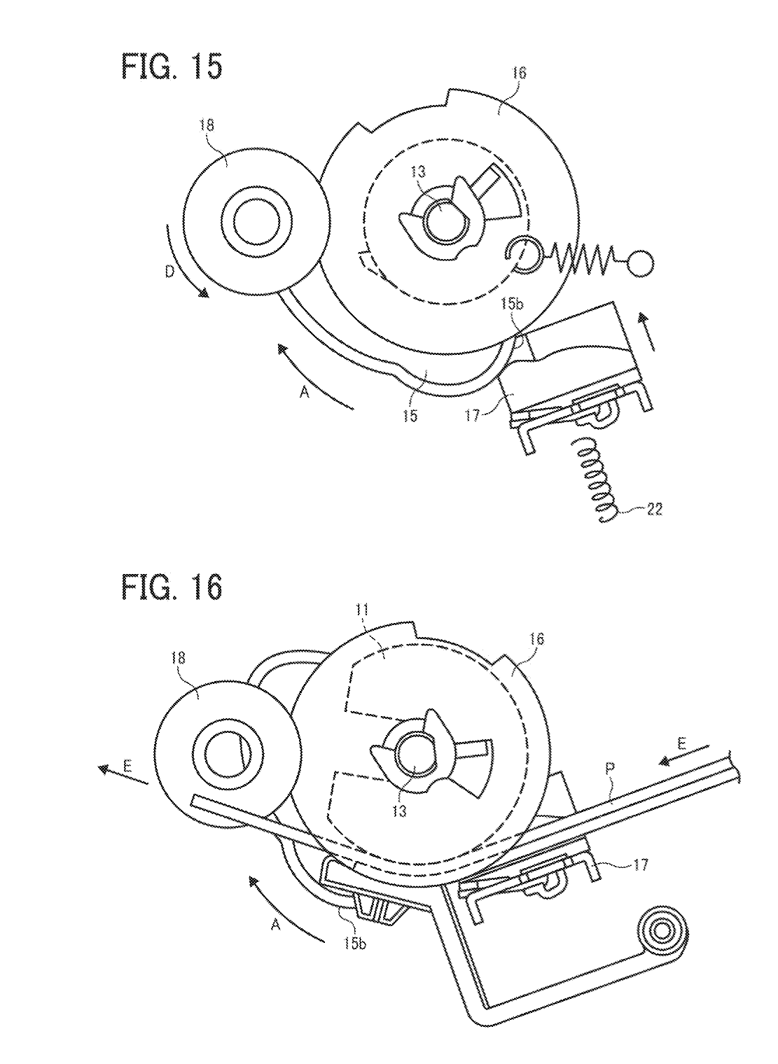

Thereafter, as illustrated in FIG. 15, the sheet feed shaft 13 and the cam 15 are rotated in the direction indicated by the arrow A while the driven gear 16 engages the drive gear 18 and the coupling means is operated. Accordingly, the bottom plate 17 contacting a surface 15b of the cam 15 is raised toward the sheet feed roller 11 by the biasing member 22 as the cam 15 rotates.

The bottom plate 17 presses the sheet P placed thereon against the sheet feed roller 11 rotating together with the sheet feed shaft 13, so that the sheet P is conveyed by the sheet feed roller 11 to a separation unit, not shown, provided downstream from the sheet feed roller 11 relative to a direction of conveyance of the sheet P. Single sheets P separated by the separation unit are then conveyed to a conveyance path provided downstream from the separation unit in the direction of conveyance of the sheet P, that is, a direction indicated by an arrow E in FIG. 16, and are further conveyed to an image printing unit provided downstream from the conveyance path relative to the direction of conveyance of the sheet P. At this time, the surface 15b of the cam 15 is separated from the bottom plate 17 as illustrated in FIG. 16 so that the sheet P is pressed against the sheet feed roller 11 by the biasing member 22.

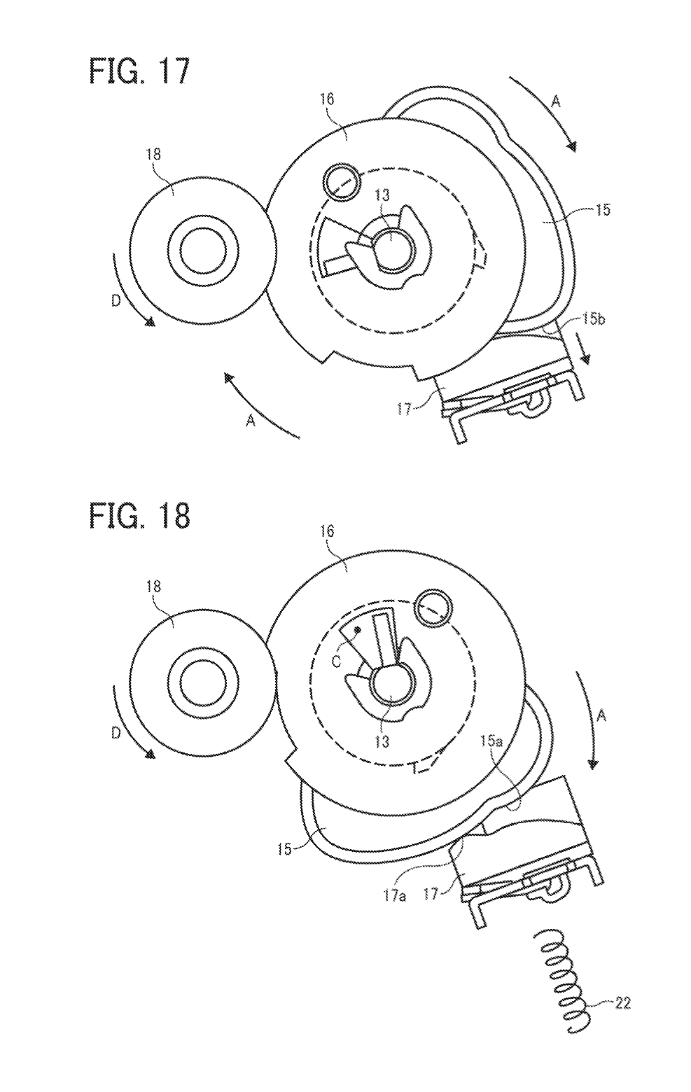

While the sheet feed shaft 13 and the cam 15 are continuously rotated, the surface 15b of the cam 15 gradually contacts the bottom plate 17 as illustrated in FIG. 17 so that the bottom plate 17 is forced downward.

Before the driven gear 16 is separated from the drive gear 18 while the sheet feed shaft 13 and the cam 15 are continuously rotated, the sheet feed shaft 13 receives torque from the biasing member 22 in a direction in which the convexity 17a engages the concavity 15a, so that the sheet feed shaft 13 starts to be rotated also by a force from the biasing member 22 as illustrated in FIG. 18. In other words, the sheet feed shaft 13 is moved relative to the driven gear 16 in the direction of rotation thereof, so that the space C reappears. At the same time, the coupling means is disengaged.

When it is separated from the drive gear 18, the driven gear 16 is rotated solely by the spring 21 serving as the driving means, and the solenoid flapper 20a engages the pick 16c to stop rotation of the driven gear 16. In other words, the gear stopping means is activated. Rotation of the sheet feed shaft 13 receiving the torque from the biasing member 22 in the direction indicated by the arrow A is stopped when the convexity 17a engages the concavity 15a, in other words, the shaft stopping means is activated, to return to the standby state illustrated in FIG. 9.

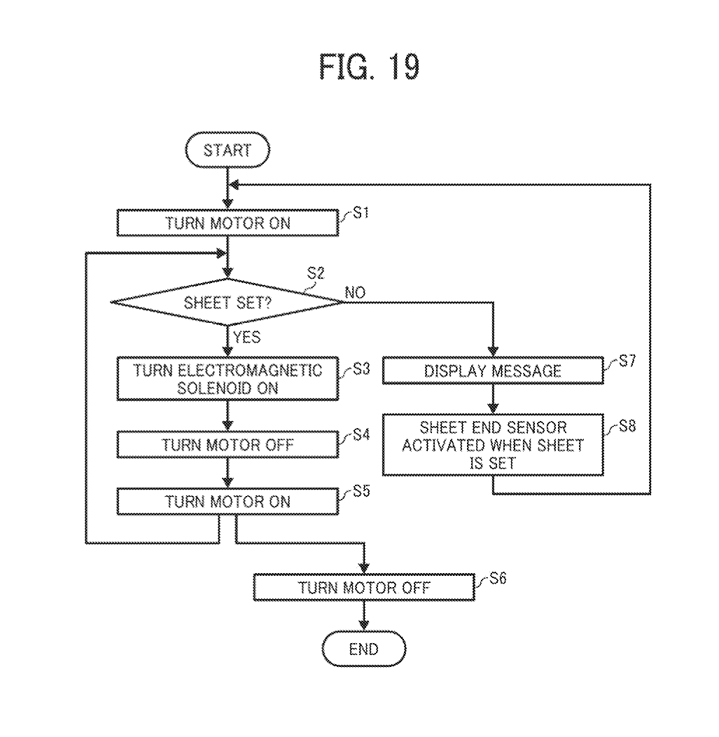

FIG. 19 is a flowchart illustrating operations of the manual sheet feeder 9 according to illustrative embodiments. It is to be noted that a roller 26 described below and the driven gear 16 can be driven by the same motor.

When a print job is started, at step S1, a motor for manual sheet feeding is turned on to start rotation of the driven gear 16 and the roller 26. At step S2, an end sensor is activated, detecting setting of the sheet P on the sheet stand 10. When the end sensor detects that the sheet P is set on the sheet stand 10 (YES at step S2), the process proceeds to step S3. By contrast, when the end sensor detects no sheet P on the sheet stand 10 (NO at step S2), the process proceeds to step S7. At step S7, for example, a message prompting the user to set the sheet P on the sheet stand 10 is displayed on a display panel or the like of an operation unit of the image forming apparatus 100, or an audio message or the like prompting the user to set the sheet P on the sheet stand 10 is conveyed to the user. At step S8, the end sensor is turned on when the sheet P is set on the sheet stand 10, and the process returns to step S1.

At step S3, the electromagnetic solenoid 20 is turned on, and is turned off, for example, from 0.2 to 0.3 seconds later. Accordingly, sheet feeding is started. The sheet feed shaft 13 is rotated one revolution, and the bottom plate 17 is raised to return to the standby state as described above. At step S4, the motor is turned off and the sheet P is bent by a pair of registration rollers 27. At step S5, the motor is turned on again to start sheet feeding again. The above-described processes from steps S2 to S5 are repeated until a predetermined number of sheets P is fed. It is to be noted that the processes of steps S7 and S8 can occur at any time during the above-described operations.

When the predetermined number of sheets P is fed, that is, when the print job is completed, at step S6 the motor is turned off to stop rotation of the driven gear 16 and the roller 26, after which operations of the image forming apparatus 100 are completed.

As described above, the bottom plate 17 is moved vertically with a simple configuration using a one-revolution clutch system.

According to the first illustrative embodiment, when the driven gear 16 engages the drive gear 18, only the driven gear 16 is rotated, thereby considerably reducing a driving force of the driving means. As a result, impact energy generated when the driven gear 16 engages the drive gear 18 can be reduced, so that operating noise of the manual sheet feeder 9 employing the one-revolution clutch system can be sufficiently reduced.

Similarly, in a case in which the solenoid flapper 20a engages the pick 16c when the driven gear 16 is separated from the drive gear 18 to return to the standby state, only the driven gear 16 is rotated, thereby considerably reducing the driving force of the driving means. As a result, impact energy generated when the solenoid flapper 20a engages the pick 16c can be reduced, so that operating noise of the manual sheet feeder 9 employing the one-revolution clutch system can be sufficiently reduced.

In addition, the manual sheet feeder 9 according to the first illustrative embodiment does not require multiple chipped gears. Accordingly, a space in the direction of the sheet feed shaft 13 can be reduced, and operating noise can be reduced with the space-saving configuration. Further, vibration, noise, and irregular images caused by phase shift between multiple chipped gears can be prevented by the manual sheet feeder 9 according to the first illustrative embodiment.

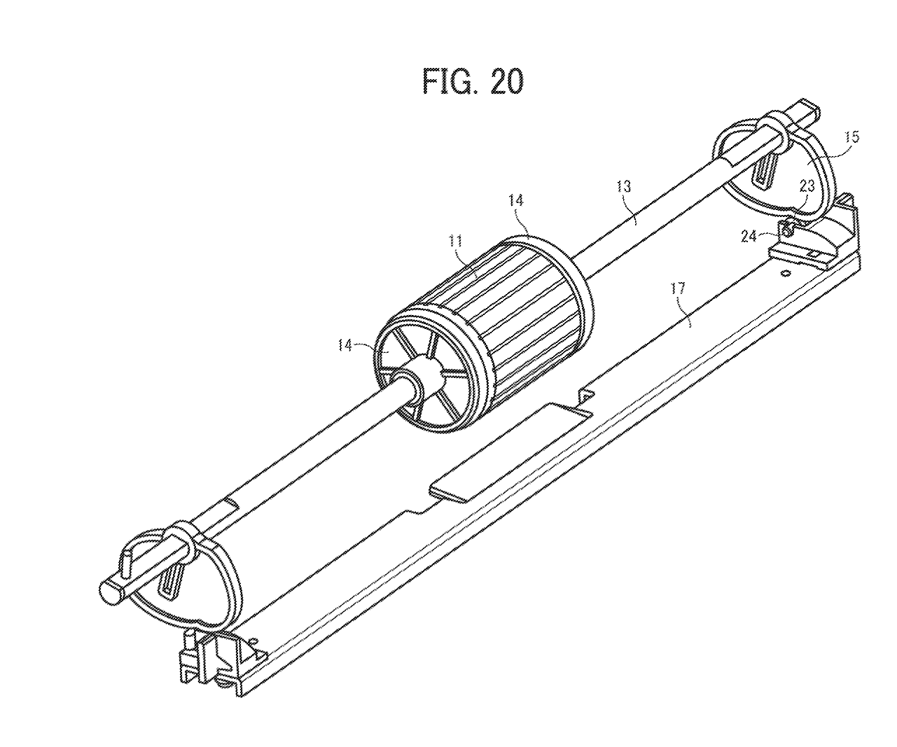

A description is now given of a second illustrative embodiment of the present invention with reference to FIGS. 20 and 21. FIG. 20 is a perspective view illustrating main components of the manual sheet feeder 9 according to the second illustrative embodiment. FIG. 21 is an enlarged perspective view illustrating the main components of the manual sheet feeder 9 illustrated in FIG. 20.

As described above, before the driven gear 16 is separated from the drive gear 18 as illustrated in FIG. 18, the sheet feed shaft 13 receives the torque from the biasing member 22 in the direction in which the convexity 17a of the bottom plate 17 engages the concavity 15a of the cam 15. However, because the cam 15 and the bottom plate 17 engage each other each time the sheet P is fed, abrasion and so forth may occur in the cam 15 and the bottom plate 17 with long-term use, causing an increase in engagement load. Consequently, the engagement load becomes greater than the torque applied to the sheet feed shaft 13 from the biasing member 22. As a result, the sheet feed shaft 13 cannot be rotated, and rotation of the sheet feed shaft 13 is stopped before the space C is provided. Even if a signal to start sheet feeding is issued again in such a state, the driven gear 16 cannot be sufficiently rotated because the space C is not provided. Consequently, the driven gear 16 cannot engage the drive gear 18, preventing sheet feeding.

To solve the above-described problem, according to the second illustrative embodiment, in place of the convexity 17a, the bottom plate 17 includes a roller member 23 having a reduced diameter and a shaft 24 as illustrated in FIGS. 20 and 21. The bottom plate 17 further includes a roller bearing 17b for the shaft 24 as illustrated in FIG. 21. Accordingly, the concavity 15a, the roller member 23, the shaft 24, and the roller bearing 17b can slide past each other, respectively, thereby reducing the engagement load between the cam 15 and the bottom plate 17. As a result, the product life of the components can be extended.

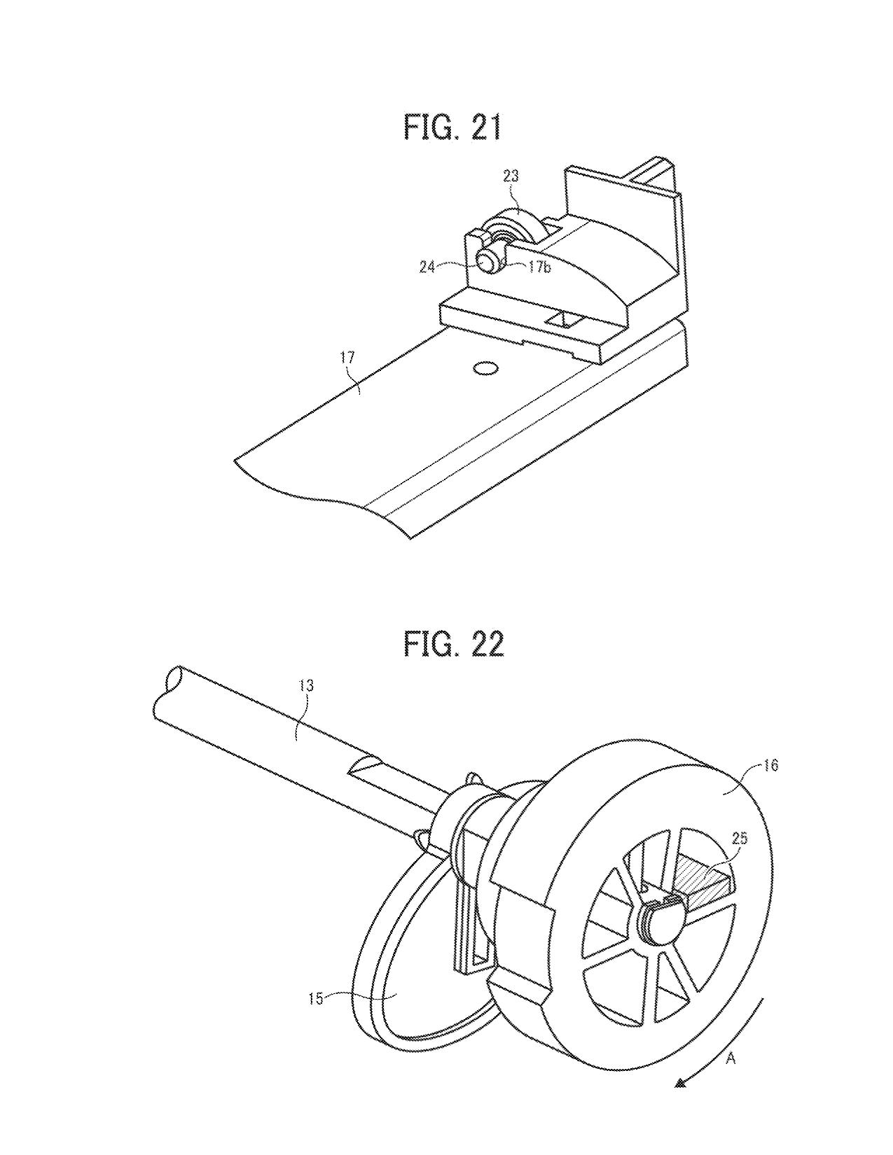

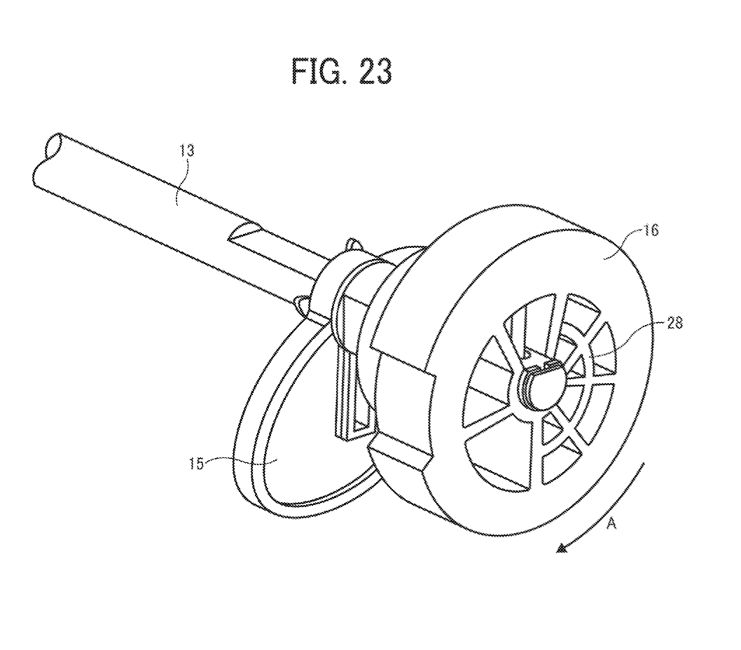

A description is now given of a third illustrative embodiment of the present invention with reference to FIGS. 22 and 23.

FIG. 22 is a perspective view illustrating an example of the driven gear 16 included in the manual sheet feeder 9 according to a third illustrative embodiment. FIG. 23 is a perspective view illustrating another example of the driven gear 16 included in the manual sheet feeder 9 according to the third illustrative embodiment.

According to the third illustrative embodiment, in order to reduce a space required for the spring 21 and the hook 16a provided to the driven gear 16 in the direction of the sheet feed shaft 13, a spindle 25 is provided to the driven gear 16 in place of the hook 16a as illustrated in FIG. 22. The spindle 25 is positioned such that the torque is applied to the driven gear 16 in the direction indicated by the arrow A in FIG. 22 by the weight of the spindle 25 in the standby state illustrated in FIG. 9. Accordingly, the spindle 25 serves as the driving means, and no space is needed for the driving means in the direction of the sheet feed shaft 13. As a result, further space saving can be achieved by provision of the spindle 25.

Alternatively, as illustrated in FIG. 23, for example, a rib 28 having a shape such that the driven gear 16 can receive the torque by its own weight may be provided in place of the spindle 25. As a result, the driving means can be provided without the spring 21 and the spindle 25, and further cost reduction can be achieved.

The foregoing illustrative embodiments herein are applied to the manual sheet feeder 9 included in the image forming apparatus 100. Because the most of the vertically movable portion of the bottom plate 17 is exposed to the user in the manual sheet feeder 9, the foregoing illustrative embodiments can effectively reduce operating noise with a space-saving configuration.

According to the foregoing illustrative embodiments, the manual sheet feeder 9 includes the sheet feed shaft 13, the semicircular sheet feed roller 11, the cam 15, and the driven gear 16 having a toothless portion, each coaxially provided to the sheet feed shaft 13. The manual sheet feeder 9 further includes the bottom plate 17 vertically movable to contact and separate from the cam 15, the driving means for moving the driven gear 16 relative to the sheet feed shaft 13 in the direction of rotation of the sheet feed shaft 13, the drive gear 18 to drive the driven gear 16, the gear stopping means for stopping rotation of the driven gear 16 at a predetermined timing, the coupling means for driving the driven gear 16 and the sheet feed shaft 13 in conjunction with each other, and the shaft stopping means for stopping rotation of the sheet feed shaft 13 are provided in the manual sheet feeder 9. Accordingly, the driving force of the driving means can be reduced, and impact energy generated when the driven gear 16 engages the drive gear 18 can be reduced, so that operating noise of the manual sheet feeder 9 employing the one-revolution clutch system can be sufficiently reduced. Further, the manual sheet feeder 9 does not require multiple chipped gears, thereby saving space.

According to the foregoing illustrative embodiments, the spring 21 is used as the driving means to simplify the configuration of the manual sheet feeder 9, thereby achieving cost reduction. In addition, the pick 16c provided to the driven gear 16 and the solenoid flapper 20a of the electromagnetic solenoid 20 that engages the pick 16c are used as the gear stopping means to simplify the configuration of the manual sheet feeder 9, thereby achieving cost reduction. Further, the parallel pin 19 provided to the sheet feed shaft 13 and the notch 16b provided on the driven gear 16 are used as the coupling means to simplify the configuration of the manual sheet feeder 9, thereby achieving cost reduction.

The convexity 17a integrally or separately provided to the bottom plate 17, the concavity 15a provided on the cam 15, and the biasing member 22 to press the bottom plate 17 toward the sheet feed roller 11 are used as the shaft stopping means in addition to raising the bottom plate 17 toward the sheet feed roller 11 and pressing the sheet P placed on the sheet stand 10 against the sheet feed roller 11, thereby achieving further cost reduction. In place of the convexity 17a, the bottom plate 17 may include the rotatable roller member 23 to reduce the engagement load between the cam 15 and the bottom plate 17. Accordingly, deterioration of the components can be prevented even with long-term use. Alternatively, the spindle 25 provided to the driven gear 16 may be used as the driving means to reduce a space in the direction of the sheet feed shaft 13, thereby achieving the space-saving configuration. Further alternatively, the driving means may be designed such that the driven gear 16 is rotated by its own weight, so that the space for the driving means is not required in the direction of the sheet feed shaft 13, thereby achieving further space saving and cost reduction.

The sheet feeder disclosed in JP-3517558-B uses the multiple gears including the first and second chipped gears as described previously. By contrast, only one gear having a toothless portion, that is, the driven gear 16, is used in the foregoing illustrative embodiments in order to achieve noise reduction, thereby saving space.

The sheet feeder disclosed in JP-3912880-B includes the disk surface to reduce operating noise as described previously. By contrast, the foregoing illustrative embodiments relate to the driving system of the driven gear 16, thereby more effectively reducing operating noise compared to the sheet feeder disclosed in JP-3912880-B.

According to the foregoing illustrative embodiments, the sheet feed shaft 13 and the driven gear 16 are movable relative to each other, and the pick 16c that engages the solenoid flapper 20a is integrally formed with the driven gear 16. Further, the impact energy itself can be reduced as described above, thereby more effectively reducing operating noise compared with the sheet feeder disclosed in JP-4139958-B.

Further, according to the foregoing illustrative embodiments, the cam 15, the sheet feed shaft 13, and the driven gear 16 are movable relative to one another. As a result, the impact energy itself can be reduced as described above, thereby more sufficiently reducing operating noise.

As can be appreciated by those skilled in the art, numerous additional modifications and variations are possible in light of the above teachings. It is therefore to be understood that within the scope of the appended claims, the disclosure of this patent specification may be practiced otherwise than as specifically described herein. For example, elements and/or features of different illustrative embodiments may be combined with each other and/or substituted for each other within the scope of this disclosure and appended claims.

This patent specification is based on Japanese Patent Application No. 2009-051868 filed on Mar. 5, 2009 in the Japan Patent Office, the entire contents of which are hereby incorporated herein by reference.

What is claimed is:

1. A sheet feeder, comprising:
a sheet feed shaft;
a partially cut-out semicircular sheet feed roller coaxially provided to the sheet feed shaft;
a cam coaxially provided to the sheet feed shaft;
a driven gear having a toothless portion coaxially provided to the sheet feed shaft;
a bottom plate movable to contact or separate from the cam;
a driving unit to move the driven gear relative to the sheet feed shaft in a direction of rotation of the sheet feed shaft;
a drive gear to drive the driven gear;
a gear stopping unit to stop rotation of the driven gear at a predetermined timing;
a coupling unit to drive the driven gear and the sheet feed shaft in conjunction with each other; and
a shaft stopping unit to stop rotation of the sheet feed shaft.

2. The sheet feeder according to claim 1, wherein the driving unit comprises a spring.

3. The sheet feeder according to claim 1, wherein the gear stopping unit comprises a stopper provided to the driven gear and an electromagnetic solenoid provided to engage the stopper.

4. The sheet feeder according to claim 1, wherein the coupling unit comprises a pin provided to the sheet feed shaft and a notch provided in the driven gear.

5. The sheet feeder according to claim 1, wherein the shaft stopping unit comprises:
a convex member provided on the bottom plate;
a concavity provided to the cam; and
a biasing member to press the bottom plate toward the sheet feed roller.

6. The sheet feeder according to claim 5, wherein the convex member comprises a rotatable roller member.

7. The sheet feeder according to claim 1, wherein the driving unit comprises a spindle provided to the driven gear.

8. The sheet feeder according to claim 1, wherein the driving unit rotates the driven gear by its own weight.

9. A sheet feeder, comprising:
a sheet feed shaft;
a partially cut-out semicircular sheet feed roller coaxially provided to the sheet feed shaft;
a cam coaxially provided to the sheet feed shaft;
a driven gear having a toothless portion coaxially provided to the sheet feed shaft;
a bottom plate movable to contact or separate from the cam;
a driving means for moving the driven gear relative to the sheet feed shaft in a direction of rotation of the sheet feed shaft;
a drive gear to drive the driven gear;
a gear stopping means for stopping rotation of the driven gear at a predetermined timing;
a coupling means for driving the driven gear and the sheet feed shaft in conjunction with each other; and
a shaft stopping means for stopping rotation of the sheet feed shaft.

10. An image forming apparatus comprising a sheet feeder, the sheet feeder comprising:
a sheet feed shaft;
a partially cut-out semicircular sheet feed roller coaxially provided to the sheet feed shaft;
a cam coaxially provided to the sheet feed shaft;
a driven gear having a toothless portion coaxially provided to the sheet feed shaft;
a bottom plate movable to contact or separate from the cam;
a driving unit to move the driven gear relative to the sheet feed shaft in a direction of rotation of the sheet feed shaft;
a drive gear to drive the driven gear;
a gear stopping unit to stop rotation of the driven gear at a predetermined timing;
a coupling unit to drive the driven gear and the sheet feed shaft in conjunction with each other; and
a shaft stopping unit to stop rotation of the sheet feed shaft.
